(19) United States
(12) Patent Application Publication
(10) Pub. No.: US 2002/0114281 A1
(43) Pub. Date: Aug. 22, 2002

(54) Method and apparatus for performance improvement of multi-service networks

(75) Inventors: Corneliu Rosu, Enskede (SE); Yngve Carl-Erik Andersson, Alta (SE); Magnus Aberg, Alvsjo (SE); Jerry Gabrielsson, Vallentuna (SE); Lasse Ostman, Stockholm (SE); Matthias Rodermann, Stockholm (SE); Bernt Carlsson, Taby (SE)

Correspondence Address: JENKENS & GILCHRIST, 3200 Fountain Place, 1445 Ross Avenue, Dallas, TX, 75202-2799, US

(73) Assignee: Telefonaktiebolaget LM Ericsson

(21) Appl. No.: 09/791,476

(22) Filed: Feb. 22, 2001

(51) Int. Cl. H04J 1/16

(52) U.S. Cl. 370/238; 370/252

(57) ABSTRACT

An arrangement is provided for evaluating the performance of different types of communication paths which may be set up in a multi-service network, wherein different paths may comprise interconnections of different single communication services such as wireless and wireline telephone systems and internet access systems. Data pertaining to at least one common performance parameter is acquired for each type of communication path, and a performance graph for each type of path is constructed from the data respectively acquired therefor. The performance graphs for respective communication paths are evaluated and compared with one another, to provide information useful for improving network performance.

### BACKGROUND OF THE INVENTION

The invention disclosed and claimed herein generally pertains to a multi-service network, that is, a network wherein different types of single service communication networks or traffic streams may be connected together, to form different types of communication paths. More particularly, the invention pertains to a method and apparatus for use in analyzing performance of multi-service networks, in order to improve performance thereof. Even more particularly, the invention pertains to an arrangement for enabling the performance of different types of communication paths in a multi-service network to be compared with one another, by means of a common standard.

As is well known by those of skill in the art, there is an ever-increasing need to be able to interconnect different single service networks, each associated with a distinctly different technology, in order to establish desired communication paths or channels. Obvious examples of single-service communication systems and technologies include, but are by no means limited to, mobile phone and other wireless telecommunication systems, landline or wireline telecommunication systems such as the Public Switched Telephone Network (PSTN), and the Internet Protocol (IP) network, used to access the internet. Each of these single service systems, as well as others which will occur to those of skill in the art, are hereinafter referred to as communication services. To illustrate the challenges involved in interconnecting communication services of different kinds, it is observed that wireless and wireline telephone networks generally employ traditional circuit switches for connectivity. On the other hand, the IP network uses packets to carry voice, data and multimedia traffic, and thus must be packet switched.

The need to interconnect communication services as described above has led to the development of multiservice networks. A multi-service network generally comprises a number of different single service networks, or communication services, which must be interconnected with one another. The multi-service network further comprises the equipment or components employed to establish or set up the connections. It will be readily apparent that communication paths established within a multi-service network can be either heterogeneous or homogeneous. A heterogeneous communication path comprises interconnected components of two or more different types of communication services, whereas a homogeneous communication path exclusively comprises components of only a single type of communication service. It will be further apparent that a communication path in a multi-service network may be thought of as a chain of connection points or elements, extending through the network between two users.

While progress has been made previously in the development of multi-service networks, further development may be impeded or constrained by certain significant problems. In particular, there is currently no methodology available which makes it possible to evaluate the overall deficiencies of a multi-service network. A principal difficulty is that a multi-service network, by its nature, must be able to combine or connect communication services associated with very different technologies. However, different service technologies frequently use different parameters to describe important operational characteristics, such as losses. Thus, at present, there is generally no uniform point of view for evaluating the impact of losses on an overall multi-service network, regardless of the type of service or technology involved. Moreover, while both vendors and operators generally have well specified performance improvement and network design processes for the different communication technologies used in a multi-service network, such processes do not always take into consideration the impact of other traffic streams or services on the network. In most cases, network management centers are dedicated or separated for different technologies. Accordingly, measures taken in one part of the multi-service network can have consequences on other parts of the network which use other technologies, wherein the consequences cannot be readily foreseen or predicted. Thus, there is a need for measurable common standards or criteria, which can be used to evaluate the end-to-end performance of any communication path which may be set up within a multi-service network. Such standards must consider all elements of the chain of connections which, collectively, are employed to set up or establish any specified communication path.

### SUMMARY OF THE INVENTION

The invention is generally directed to a multi-service network, which comprises a number of different communication services and is operable to establish different types of homogeneous and heterogeneous communication paths. As stated above, each homogeneous communication path comprises interconnected components of only a single one of the communication services, and each heterogeneous communication path comprises interconnected components of different services. It is anticipated that an embodiment of the invention will be able to provide a common basis for evaluating performance of all types of communication paths which can be constructed through or within a multi-service network. Such common basis for evaluation will apply to both heterogeneous and homogeneous communication paths, regardless of the technologies respectively associated therewith. Thus, the performance of respective communication paths can readily be compared with one another, leading to a number of benefits and advantages as described hereinafter.

In one aspect, the invention provides system operators with standard measureables to establish trends and proactively deal with them. The measureables are related to the end-to-end performance of a network path, considering all elements of the connection chain. Thus, analysis is not fragmented amongst different technologies. Moreover, the measureable standards may be readily used and easily understood by operations and maintenance staff who do not have advanced academic degrees, or equivalent high levels of training.

The invention, in one embodiment, is a method which includes the step of acquiring data pertaining to at least one common performance parameter for each type of communication path in a multi-service network as described above. The method further comprises the steps of constructing a performance graph for each type of communication path, from the data respectively acquired therefor, and comparing the performance graph of any one type of communication path of the network with the performance graph of any other type of communication path. The performance graph of a particular type of communication path may also be compared with a performance graph for the same path, or type of path, acquired at a different time and/or under different operating conditions.

In the invention, it has been recognized that all of the communication paths which can be set up in the multi-service network have certain features or characteristics in common, regardless of whether respective paths are heterogeneous or homogenous, and regardless of the technology or technologies associated therewith. More specifically, every path may be characterized as an attempt to establish communication between a first user and a second user, and may be further characterized by whether the effort is successful or unsuccessful. Thus, in accordance with the invention, data pertaining to these attempts and successes, as well as to the level of losses, may be used to provide the performance parameters referred to above, and performance graphs may be constructed therefrom.

It is to be noted that in telephony, the establishment of a communication path between two users is referred to as a “call.” In contrast, the establishment of a path between two computer users, such as by means of the Internet, is referred to as a “connection.” Still other terms may be used in other communication technologies. Thus, in order to provide uniformity, the term “connection” is used generically herein to refer to the establishment of any homogenous or heterogeneous communication path through the multi-service network, as described above.

In view of the above, in a preferred embodiment of the invention at least one of the performance parameters comprises a representation of the number of connections successfully completed through a communication path, relative to the number of connections attempted. Such representation may, for example, express successful connections as a percentage of the total number of connections attempted. Preferably, the method further includes the step of selectively altering a specified characteristic of the multi-service network, and then determining effects of the selected alteration on the performance of respective communication paths. Preferably also, the multi-service network includes wireless, wireline, and/or internet communication services.

In one useful embodiment, the data acquisition step comprises selectively operating the multi-service network to establish communication paths of the respective different types, and then measuring the values of the performance parameters for each established communication path. Alternatively, the data acquisition step may comprise accessing a database, such as a database of connection/call detail records, or a centralized connection/call information database.

By providing a common standard or basis for comparing different types of interconnected service paths in a multi-service network, the invention enables operators thereof to determine which types of service inter-connections are most profitable. Such information may be extremely useful to network operators in their business planning. Also, it is anticipated that the invention will enable operators to more readily locate or identify deficiencies within a multi-service network, so that limited resources can be concentrated to correct the deficiencies. For example, simply by comparing the performance graphs of two different types of communication paths, it could become readily apparent that there were significantly more faults in one path than in the other. As a further advantage, the invention will more readily enable certain evaluations and analyses in a multi-service network. For example, in a model of the network, a characteristic or feature of one of the communication services may be selectively altered. An embodiment of the invention can then be employed to determine the “global impact” of the alteration, that is, the impact or effect thereof on each of the other services and on different interconnections thereof.

### BRIEF DESCRIPTION OF THE DRAWINGS

FIG. 1 is a schematic diagram showing a multi-service network, together with certain single services associated therewith, which may be used in connection with an embodiment of the invention.

FIG. 2 is a schematic diagram showing a matrix pertaining to different single communication services which is useful for illustrating a basic concept of the invention.

FIG. 3 depicts a performance graph for an embodiment of the invention.

FIG. 4 is a block diagram depicting a simplified arrangement for constructing the performance graph of FIG. 3.

### DETAILED DESCRIPTION OF THE PREFERRED EMBODIMENT

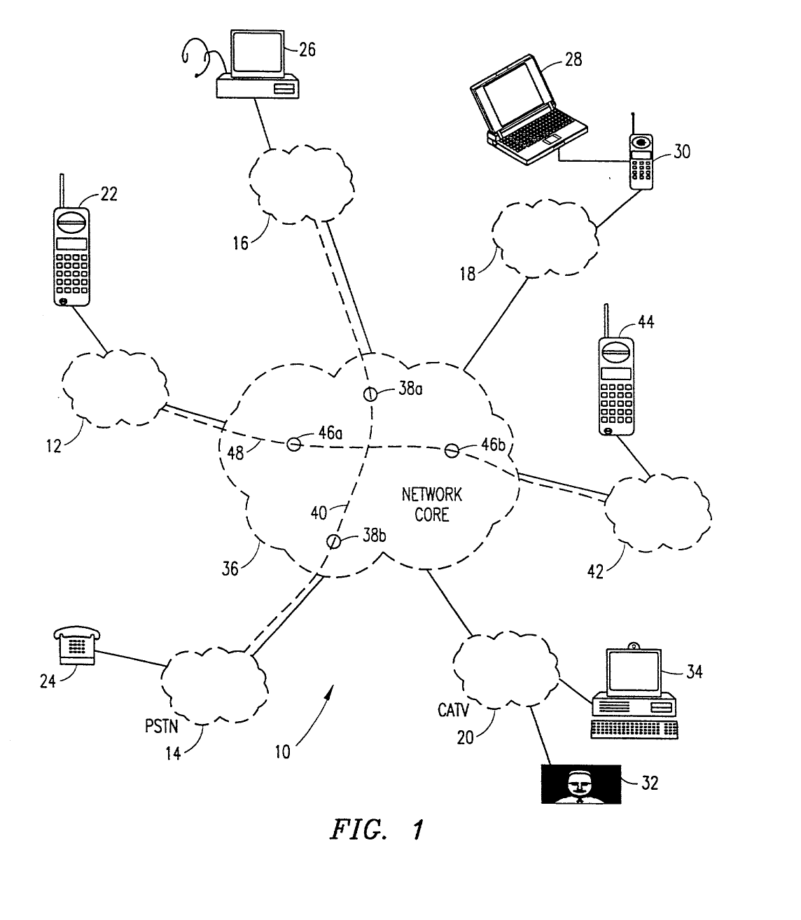

Referring to FIG. 1, there is shown a multi-service network 10 which, as described above, comprises a number of different types of communication services 12-20 which may, for example, be different single service networks. Thus, communication service 12 comprises a wireless telephone network, and users thereof may employ mobile phones 22 for transmission and reception. Communication service 14 comprises a land line or wire line network such as PSTN, and users may employ a conventional wire line telephone 24 therewith. However, fax machines and other equipment conventionally designed for direct connection to a wire line network may also be used therewith. Communication service 16 comprises a network such as the IP network for connecting personal computers (PC) 26 and the like to the Internet. Similarly, communication service 18 comprises a network for coupling a laptop computer 28 to the Internet, through a wireless phone 30. Communication service 20 comprises a cable TV network for transmitting and receiving video images 32, by means of a video input/output (I/O) device 34, such as a video camera or display device.

Referring further to FIG. 1, there is shown multi-service network 10 provided with a network core 36 connected to each of the communication services 12-20. Core 36 comprises an array of equipment and other components (not shown) which are collectively operable to establish bi-directional paths for communicating information between users of any two of the services 12-20. Suitable equipment and components will readily occur to those of skill in the art and include, by way of example, a product of assignee Telefonaktiebolaget LM Ericsson publ, which is known commercially as the Media Gateway AXC 711. It is to be emphasized, however, that there is no intent to limit the invention thereto. Also by way of example and not limitation, FIG. 1 shows network core 36 operated to connect wire line service 14 to IP service 16, at nodes 38a and 38b, in order to set up a communication path 40 extending between the services 14 and 16. Thus, multi-service network 10 may be readily employed to transmit information between a user of telephone 24 and a user of PC 26.

It is to be emphasized further that multi-service network 10 can include other types of communication services besides or in addition to services 12-20. Moreover, to emphasize the diverse utility of multi-service network 10, FIG. 1 shows a wireless communication service 42 connected thereto or included therein, wherein service 42 may be similar or identical to wireless service 12 described above. By judicious operation of network core 36, wireless communication services 12 and 42 can be connected together at nodes 46a and 46b, in order to set up a communication path 48 extending between wireless services 12 and 42. Thus, multi-service network 10 may also be used to transmit information between users of the same type of communication service, such as the respective users of mobile phones 22 and 44. As described above, path 40 extending between services 14 and 16 may be referred to as a heterogeneous communication path, whereas the path 48 extending between services 12 and 42 may be referred to as a homogeneous communication path.

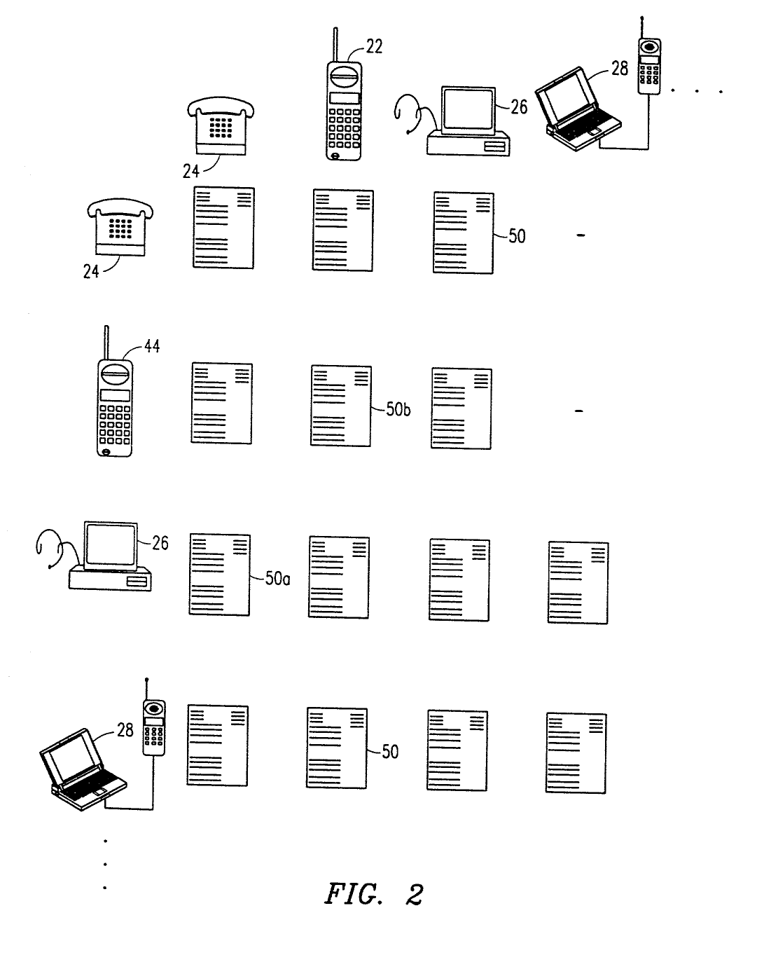

Referring to FIG. 2, there is shown a network service oriented matrix, which is useful for illustrating compilation of a traffic profile of multi-service network 10. Each row and column of the matrix is identified by one of the I/O devices 22-28, respectively associated with communication services 12-18 shown in FIG. 1. It is to be understood that a terminal associated with each device may be readily connected to terminals associated with other devices. Each position of the matrix contains a performance graph 50, described hereinafter in further detail, which sets forth values of certain performance parameters for one of the communication paths of multi-service network 10. More specifically, the performance graph positioned at the intersection of a particular row and column of the matrix is constructed from performance data of a communication path which is formed by interconnecting the communication services associated with the particular row and column, respectively. Thus, performance graph 50a is constructed from data acquired from heterogeneous communication path 40 shown in FIG. 1, connecting telephone 24 and PC 26. In like manner, performance graph 50b is constructed from data acquired from homogenous communication path 48. It is to be understood that a homogenous communication path could be established from two separate networks of the same type, such as two mobile phone networks connected together through network core 36. Alternatively, a homogenous path could be established from components of a single service or network interconnected with network core 36.

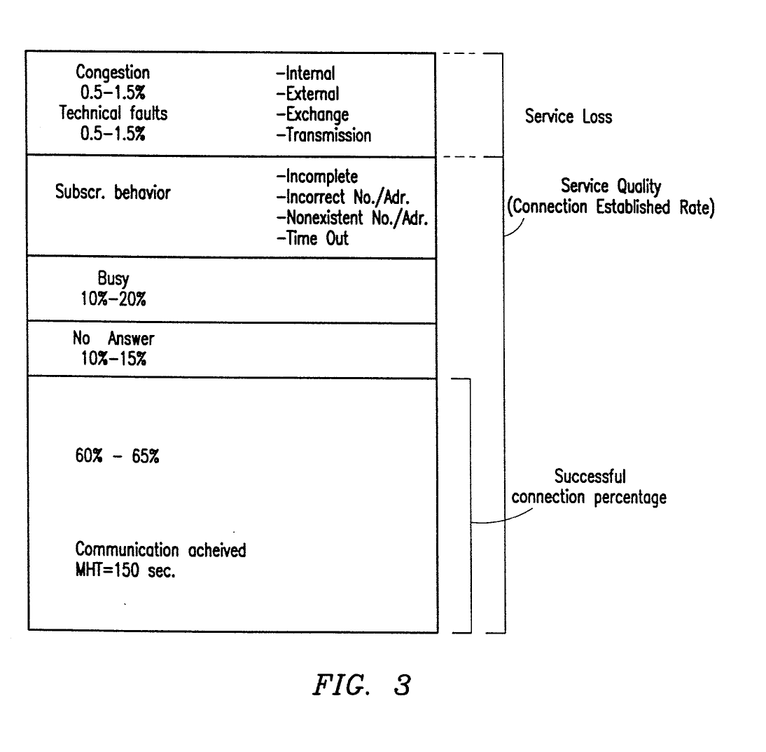

Referring to FIG. 3, there is shown a performance graph 50 of a type disclosed in commonly assigned U.S. Pat. No. 5,359,649, which names one of the co-inventors herein as a patentee. The performance graph 50 of FIG. 3, which is associated with a particular communication path of multi-service network 10, is usefully obtained from service quality statistics measurements. The parameter identified as service loss is the total loss of service due to congestions, lost cells or delays and technical faults, and is expressed as a percentage of the total connections, as such term is defined above, which are attempted. In evaluating service loss, a differentiation is made between technical losses, such as those due to exchange faults and transmission faults, and traffic losses such as those due to internal and external exchange congestion, system delays, and to network traffic management actions. Another communication path performance variable, service quality (estimated successful connections established rate) is calculated as 100% minus the service loss. This variable includes all connections which do not result in communication between users or subscribers, and thus includes losses resulting from subscriber behavior, rather than losses resulting from technical faults and traffic congestion. As also illustrated in FIG. 3, subscriber behavior losses include connections in which the initiating subscriber is timed out, an incorrect or nonexistent number or address is accessed, and the initiating subscriber hangs up or disconnects prematurely (incomplete connection). Further losses, associated with the recipient subscriber, occur when the recipient subscriber is busy or does not answer, the recipient equipment is out of order, and the recipient is barred from responding to incoming connections. The successful connection percentage is the percentage of connections which result in actual communication. Thus, the performance graph shown in FIG. 3 provides very useful information, that is, the number of connections which are successful from the subscriber's point of view, as a percentage of a specified total number of connections attempted, over the communication path with which the performance graph is associated.

It will be appreciated that when performance graphs are available for each communication path which can be set up in multi-service network 10, the information for each graph can be evaluated and compared with the information for other graphs. Such analysis will indicate, for example, the components of the network which have the greatest rates of service loss, and which should therefore be the focus of available corrective resources. Also, if a characteristic of one of the communication services of the network is changed or altered, performance graphs generated for respective communication paths before the change can be compared with corresponding graphs generated after the change. Such comparisons will be very useful in assessing the impact which the change in a single service may have throughout a multi-service network, or upon a model thereof. For example, in one important application, comparison of performance graphs in accordance with the invention could provide early notification that an overload condition was developing in one type of service, which could lead to overload or deterioration of other types of services or the entire network. Such early notification would enable corrective action to be taken right away.

It is to be emphasized that the type of parameter data used in constructing respective performance graphs 50 is applicable to all communication paths which can be established in the multi-service network. That is, data pertaining to connections attempted, to connections lost and to connections successfully established or set up is measurable and has the same significance for every communication path, regardless of the technology or technologies respectively associated therewith. Accordingly, the performance graphs described above provide common criteria or standards for evaluation and analysis in a multi-service network. Moreover, in addition to enabling meaningful comparisons between two different types of communications paths, the graphs provide a useful tool for evaluating performance of a particular type of communication path, at different times or under different operating conditions. For example, the successful connections rate of a communication path could be weighted by a factor such as 1%. A change of more than 1% in the successful connections rate for the path would be noted and regarded as significant.

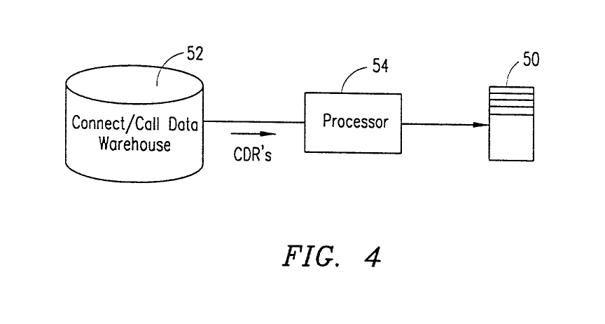

In an alternative embodiment of the invention, the data required to construct respective performance graphs may be acquired from Connection/Call Detail Records (CDR's), rather than from direct measurement. Suppliers of telecommunication services frequently generate and store CDR's for each call or connection. CDR's may be retained in a connection/call data warehouse, a facility for storing normalized data for long periods of time. Referring to FIG. 4, there is shown a data warehouse 52 supplying CDR's to a processor 54. Processor 54 is operable to extract information from received CDR's which pertain to a particular communication path, and to construct a performance graph 50 from the extracted information which pertains to the particular path. Alternatively, processor 54 can be operated to generate a number of performance graphs internally, and to make comparisons therebetween to provide useful conclusions in regard to the performance of an associated multi-service network.

In a further embodiment of the invention, data for constructing the performance graphs may be supplied to processor 54 from a large centralized data base. For example, certain countries maintain very extensive data bases of all telecommunication calls and connections. In another useful application, an embodiment of the invention may be used in a proactive mode. In such embodiment, for a selected type of communication path a series of test connections or calls are directed from a central location to different preselected locations, addresses or numbers. A test connection, as used herein, refers to an effort to establish a communication path with a preselected location only to see if the path can be successfully set up, not to communicate with a user or subscriber at the location. Data pertaining to the results, that is, the number of connections attempted and the number of connections successfully established, are recorded and used to construct a performance graph and traffic profile for the selected path. If the acquired data indicates that the successful connection rate is too low, or decreases by an amount greater than a weighting factor such as 1%, corrective action may be taken. Such proactive operation has the benefit of detecting problems in the selected communication path, so that the problems can be fixed or corrected before subscribers are affected by them.

Although a preferred embodiment of the present invention has been illustrated in the accompanying Drawings and described in the foregoing Detailed Description, it will be understood that the invention is not limited to the embodiment disclosed, but is capable of numerous rearrangements, modifications and substitutions without departing from the spirit of the invention as set forth and defined by the following claims.

What is claimed is:

1. In a multi-service network comprising a number of different communication services, and operable to establish selected different types of homogeneous and heterogeneous communication paths, a network performance analysis method comprising the steps of:
acquiring data pertaining to at least one common performance parameter for each of said types of communication paths;
constructing a performance graph for each of said types of communication paths from the data respectively acquired therefor; and
comparing the performance graph of any one of said communication paths of said multi-service network with the performance graph of any other of said communication paths to generate specified information pertaining to performance of said network.

2. The method of claim 1 wherein:
said at least one performance parameter comprises a representation of the number of connections successfully completed, relative to a specified number of connections attempted.

3. The method of claim 1 wherein:
said method further includes the step of altering a characteristic of said multi-service network, and employing said comparing step to determine effects of said alteration on respective communication paths of said network.

4. The method of claim 1, wherein said data acquisition step comprises:
selectively operating said multi-service network to establish communication paths of each of said different types; and
measuring the values of said respective performance parameters for each of said established communication paths.

5. The method of claim 1, wherein:
said data acquisition step comprises accessing a database comprising connection charging records.

6. The method of claim 1, wherein:
said data acquisition step comprises accessing a centralized connection information database.

7. The method of claim 1, wherein:
said multi-service network includes at least one service selected from a group comprising wireless, wireline and internet communication services.

8. The method of claim 1 wherein said data acquisition step comprises:
for a selected type of communication path, initiating efforts to implement a series of test connections to set up communication paths between a specified central location and each of a number of preselected locations; and
recording the results of said test connection efforts for use in detecting an error in said selected type of communication path.

9. In a multi-service network comprising a number of different communication services, a method for analyzing performance of said network comprising the steps of:
operating said multi-service network to establish selected homogeneous and heterogeneous communication paths within said network;
acquiring data pertaining to at least one common performance parameter for each of said established communication paths;
constructing a performance graph for each of said established communication paths from the data respectively acquired therefor; and
employing respective performance graphs to selectively analyze performance of said network.

10. The method of claim 9 wherein:
said at least one performance parameter comprises a representation of the number of connections successfully completed, relative to a specified number of connections attempted.

11. The method of claim 10 wherein:
said step of employing performance graphs comprises comparing the performance graph of any one of said established communication paths with the performance graph of any other of said established communication paths to generate specified information pertaining to performance of said network.

12. The method of claim 11 wherein:
said network is operated to establish first and second communication paths of the same type, and data for constructing performance graphs for said first and second performance graphs, respectively, is acquired while said first and second graphs are being operated under selectively different conditions.

13. The method of claim 10, wherein:
for a selected type of communication path, said network attempts to implement a series of test connections to set up specific communication paths between a specified central location and each of a number of preselected locations; and
the results of said attempts are recorded for each of said test connections and used to construct performance graphs respectively pertaining thereto, the performance graphs being used to detect errors in said selected path.

14. The method of claim 10 wherein said data acquisition step comprises:
measuring the values of said performance parameters for each of said established communication paths.

15. The method of claim 10 wherein:
said data acquisition step comprises accessing a database comprising connection charging records.

16. The method of claim 10 wherein:
said multi-service network includes at least one service selected from a group comprising wireless, wireline and internet communication services.

17. In a multi-service network comprising a number of different communication services, and operable to establish selected different types of homogeneous and heterogeneous communication paths, apparatus for analyzing performance of said network comprising:
a data base containing data pertaining to at least one common performance parameter for each of said types of communication paths;
a processor disposed to construct a performance graph for each of said types of communication paths from data respectively pertaining thereto which is contained in said database; and
said processor is further disposed to compare the performance graph of any one of said communication paths of said multi-service network with the performance graph of any other of said communication paths to generate specified information pertaining to performance of said network.

18. The apparatus of claim 17 wherein:
said at least one performance parameter comprises a representation of the number of connections successfully completed, relative to a specified number of connections attempted.

19. The apparatus of claim 17 wherein:
said processor is adapted to generate information pertaining to effects on performance of said network resulting from alteration of a specified characteristic thereof.

20. The apparatus of claim 17 wherein:
said multi-service network includes at least one service selected from a group comprising wireless, wireline and internet communication services.
